(19) United States
(12) Patent Application Publication
(10) Pub. No.: US 2017/0083061 A1
(43) Pub. Date: Mar. 23, 2017

(54) HYBRID THERMAL SOLUTION FOR ELECTRONIC DEVICES

(71) Applicant: Microsoft Technology Licensing, LLC, Redmond, WA (US)

(72) Inventors: Taylor Stellman, San Francisco, CA (US); Andy Delano, Woodinville, WA (US); Andrew Hill, Redmond, WA (US)

(21) Appl. No.: 14/862,289

(22) Filed: Sep. 23, 2015

(51) Int. Cl. G06F 1/20

(52) U.S. Cl. CPC G06F 1/203

(57) ABSTRACT

Various techniques for removing heat from electronic devices are disclosed herein. In one embodiment, an electronic device includes a processor having a first surface area and a heat spreader in direct contact with the processor. The heat spreader has a second surface area greater than the first surface area of the processor. The electronic device also includes a housing panel spaced apart from the heat spreader by a gap. The housing panel has an air inlet proximate a first end of the gap and an air outlet proximate a second end of the gap. The electronic device further includes an air mover configured to move cooling air through the gap from the air inlet toward the air outlet of the housing panel.

### BACKGROUND

Tablets, laptop computers, smart phones, and other modern electronic devices typically include one or more heat producing components such as processors. The heat produced during operation can damage the electronic devices and/or degrade performance if not adequately dissipated. Various techniques have been developed to dissipate heat produced by such heat producing components. For example, a fan can be positioned on a processor to force cold air to flow past the processor and carry away heat from the processor.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Modern designs of electronic devices aim to provide thinner, lighter, or slimmer models than previous ones. For example, the thickness of the fifth generation Apple MacBook Air® is 0.51″ compared to 0.68″ of the previous generation. Such reduction in thickness (or other dimensions) however, may render certain heat dissipating techniques unfeasible and/or inadequate. For instance, a small thickness of a tablet or laptop computer may not provide sufficient internal spacing for mounting a fan on a processor in the tablet or laptop computer. In addition, forcing a large amount of air through a small internal space can create unacceptable noise levels during operation.

Several embodiments of the disclosed technology are directed to hybrid heat dissipation systems that combine active and passive heat dissipation techniques to achieve target levels of heat removal. In one example, the heat dissipation system can include a heat spreader having a first surface in contact with a heat source (e.g., a processor) in an electronic device. The heat spreader is configured to transfer and distribute heat generated by the heat source from the first surface to a second surface having a large surface area in order to enhance passive heat dissipation from the electronic device via natural convection and/or radiation. The heat dissipation system can also include an air mover proximate the heat spreader. The air mover is configured to force cooling air through a gap between a housing panel of the electronic device and the second surface of the heat spreader to remove heat from the second surface via forced convection. In other examples, the air mover can also force a portion of the external air through another gap that is between the first surface of the heat spreader and another housing panel.

Several embodiments of the heat dissipation system can accommodate thin profiles (e.g., thicknesses of about 5.0 mm to about 9.2 mm) for electronic devices and still provide sufficient heat dissipation without unacceptable operating noise levels. It has been recognized that thin profiles of electronic devices can limit the amount of heat removed via forced convection because small thicknesses typically limit physical size and airflow capacity of air movers suitable for such electronic devices. Even if small size air movers with large airflow capacities are available, forcing a large amount of cooling air through a small internal space of electronic devices can produce unacceptable noise levels. Thus, by enhancing, optimizing, or maximizing passive heat dissipation of a portion of the generated heat, size and/or air flow capacity of air movers can be reduced to provide sufficient heat removal via forced convection without excessive operating noises.

### BRIEF DESCRIPTION OF THE DRAWINGS

FIG. 1A is a schematic diagram illustrating a cross-sectional view of an electronic device having a heat dissipation system configured in accordance with embodiments of the disclosed technology.

FIGS. 1B-1F are schematic diagrams illustrating top views of various embodiments of the electronic device of FIG. 1A configured in accordance with embodiments of the disclosed technology.

FIGS. 2A-2C are schematic diagrams illustrating cross-sectional and top views of additional embodiments of the heat spreader of FIG. 1A configured in accordance with embodiments of the disclosed technology.

FIG. 3 is a schematic diagram illustrating cross-sectional views of additional embodiments of the electronic device of FIG. 1A configured in accordance with embodiments of the disclosed technology.

FIGS. 4A and 4B are top and cross-sectional views of a heat spreader suitable for the electronic device of FIGS. 1A-3.

FIG. 5 is a flowchart illustrating a process of removing heat from a heat source in an electronic device in accordance with embodiments of the disclosure.

FIG. 6 is a schematic diagram of an electronic device that can include a heat dissipation system configured in accordance with embodiments of the disclosure.

### DETAILED DESCRIPTION

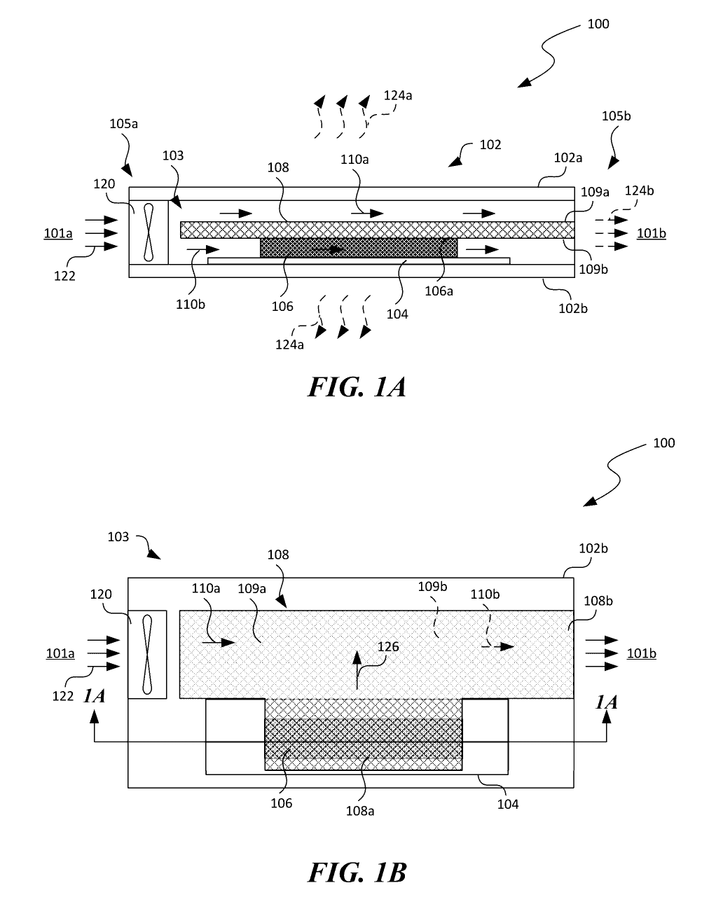

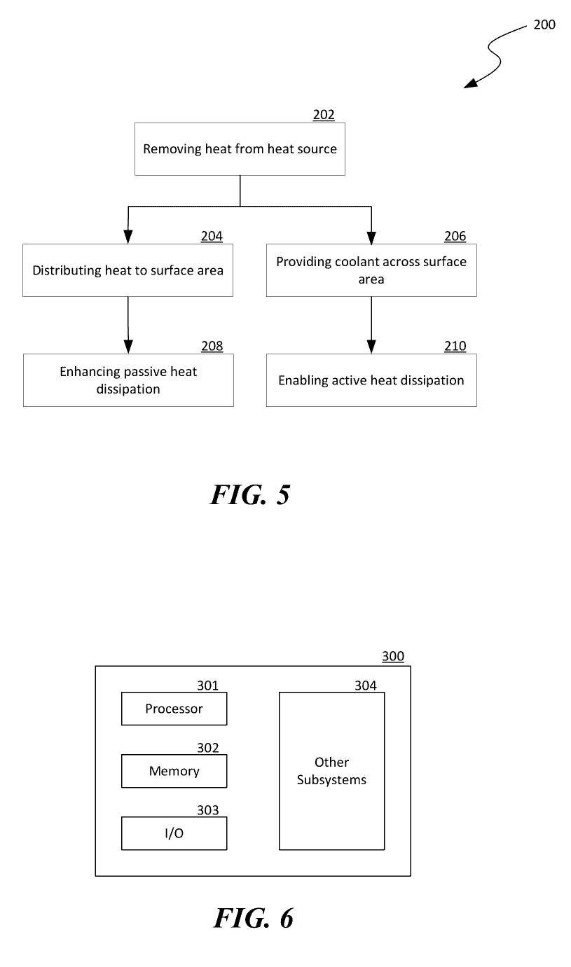

Certain embodiments of systems, devices, components, modules, and processes for heat dissipation in electronic devices are described below. In the following description, specific details of components are included to provide a thorough understanding of certain embodiments of the disclosed technology. A person skilled in the relevant art would also understand that the disclosed technology may have additional embodiments or may be practiced without several of the details of the embodiments described below with reference to FIGS. 1A-6.

As used herein, the term “electronic device” generally refers to a device that accomplishes designed functions electronically. Example electronic devices can include, without limitation, a tablet computer, a laptop computer, a smart phone, a digital copier, a digital scanner, and a television set. An electronic device can include one or more heat producing components, such as logic processors, graphics processors, and/or other suitable processing components. As described in more detail later, an electronic device configured in accordance with embodiments of the disclosed technology can also include a heat dissipation system that combines active and passive heat dissipation techniques.

Also used herein, the term “active” heat dissipation generally refers to heat dissipation that requires external energy input. One example active heat dissipation technique includes removing heat via forced convection by using a fan to provide and/or exhaust cooling air. Another example includes removing heat via conduction using a chiller and a heat exchanger. In contrast, the term “passive” heat dissipation generally refers to heat dissipation without requiring external energy input. Example passive heat dissipation techniques include removing heat from a heat source via natural convection and/or radiation. The term “hybrid heat dissipation” generally refers to heat dissipation via combinations of active and passive heat dissipation techniques.

FIG. 1A is a schematic diagram illustrating a cross-sectional view of an electronic device 100 having a heat dissipation system configured in accordance with embodiments of the disclosed technology. As shown in FIG. 1A, the electronic device 100 can include a housing 102 enclosing various internal components of the electronic device 100. Even though particular components are shown in FIG. 1A and other Figures herein, in other embodiments, the electronic device 100 can also include buttons, switches, power supplies, and/or other suitable types of components.

As shown in FIG. 1A, the housing 102 can include a first housing panel 102a opposite a second housing panel 102b. The first and second housing panels 102a and 102b can be coupled to each other via pressure fitting, adhesives, fasteners, and/or other suitable assembly techniques. The housing 102 can also include an air inlet 101a and an air outlet 101b proximate first and second edges 105a and 105b of the housing 102, respectively. In certain embodiments, at least one of the first or second housing panel 102a and 102b can include a touch screen, a display (e.g., an LED or LCD display), a keyboard, one or more mechanical/electrical buttons, switches, keys, or other suitable components (not shown). In other embodiments, the first or second housing panel 102a and 102b can also include a cover plate, a structural frame, or other support structures constructed from a metal, a metal alloy, a polymeric material, glass, or other suitable materials.

In the illustrated embodiment in FIG. 1A, the internal components of the electronic device 100 includes a substrate 104, a heat source 106 carried by the substrate 102, and a heat dissipation system 103 operatively coupled to the heat source 106. The substrate 104 can include a printed circuit board (e.g., a motherboard) or other suitable supporting components. The heat source 106 can include a central processing unit, a graphics processing unit, a signal processing unit, or other suitable electronic components that produce heat during operation. Though only one heat source 106 is shown in FIG. 1A, in other embodiments, the electronic device 100 can include two, three, or any suitable number of heat sources 106 (not shown) carried by the substrate 104.

As shown in FIG. 1A, in certain embodiments, the heat dissipation system 103 can include a heat spreader 108 in direct contact with the heat source 106 and an air mover 120 proximate the air inlet 101a. In other embodiments, the heat dissipation system 103 can also include additional and/or different components arranged in other suitable manners, for example, as described in more detail below with reference to FIGS. 1B-1F.

As shown in FIG. 1A, the heat spreader 108 can include a plate-like structure having a first surface 109a opposite a second surface 109b The second surface 109b of the heat spreader 108 is in direct contact with a top surface 106a of the heat source 106. Though not shown in FIG. 1A, in certain embodiments, the electronic device 100 can also include a thermally conductive adhesive (not shown) between the second surface 109b and the top surface 106a of the heat source 106. In other embodiments, the heat spreader 108 can also be fastened to the heat source 106 using fasteners, compression fittings, or other suitable techniques.

In the illustrated embodiment, the first surface 109a of the heat spreader 108 is spaced apart from the first housing panel 102a by a first gap 110a. The second surface 109b is spaced apart from the second housing panel 102b by a second gap 110b. The first and second gaps 110a and 110b can extend laterally at least partially between the air inlet 101a and the air outlet 101b of the housing 102. In certain embodiments, the first and/or second gaps 110a and 110b can be sized to allow a laminar flow of cooling air through the first and/or second gaps 110a and 110b. In other embodiments, the first and/or second gaps 110a and 110b can be sized to allow a flow of cooling air at other desired values of Reynolds number that may or may not be in the laminar range (e.g., about 10 to about 2,000). In further embodiments, the electronic device 100 may include only one of the first or second gap 110a or 110b, for example, by blocking the second gap 110b with the heat source 106.

The heat spreader 108 can be configured to remove heat from the heat source 106 and distribute the removed heat to a larger surface area of the first and second housing panels 102a and 102b than that of the heat source 106. In one embodiment, the heat spreader 108 can include a vapor chamber having a thermal conductivity of about 4000 W/mK to about 6,000 W/mK. One vapor chamber suitable for the electronic device 100 is the Therma-Base® vapor chamber provided by Thermacore, Inc. of Lancaster, Pa. In other embodiments, the heat spreader 108 can include a plate, a mesh, or other suitable structures constructed from copper, graphite, or other suitable materials with thermal conductivities greater than about 400 W/mK.

The air mover 120 can be positioned to force cooling air 122 to flow past and remove heat from the first and/or second surfaces 109a and 109b of the heat spreader 108 via forced convection. In the illustrated embodiment, the air mover 120 is positioned proximate the air inlet 101a of the housing 102 to draw cooling air 122 into the electronic device 100. In other embodiments, the air mover 120 can also be positioned proximate the air outlet 101b to exhaust cooling air 122 from the electronic device 100. In further embodiments, the electronic device 100 can also include two air movers (not shown) positioned at the air inlet 101a and air outlet 101b, respectively. The air mover 120 can include a squirrel cage fan, a vane-axial blower, a centrifugal fan, an axial fan, and/or other types of suitable air moving devices. One example air mover suitable for the electronic device 100 is HP Blower Fan P/N C3595-60008 provided by Hewlett-Packard Company of Palo Alto, Calif.

During operation, the heat source 106 produces heat that needs to be dissipated. The heat spreader 108 removes at least a portion of the produced heat via conduction through the second surface 109b and distributes the removed heat to a larger surface area of the first and second housing panels 102a and 102b than that of the heat source 106 via conduction and/or radiation. The substrate 104 can also transmit another portion of the produced heat to the second housing panel 102a via conduction and/or radiation. The heated first and second housing panels 102a and 102b can then dissipate the received first portion of the heat to external environment via natural convection and/or radiation, as indicated by the arrows 124a.

Simultaneously, the air mover 120 can force the cooling air 122 to flow through the first gap 110a and the second gap 110b from the air inlet 101a towards the air outlet 101b in a direction generally tangential to the first and second surfaces 109a and 109b of the heat spreader 108. As the cooling air 122 moves past the first and second surfaces 109a and 109b, the cooling air 122 removes heat from the heat spreader 108 via forced convection. The heated cooling air 122 in turn can also transfer a part of the removed heat to the first and second housing panels 102b and 102b via forced convection. As the heated cooling air 122 exits the electronic device 100 via the air outlet 101b, the cooling air 122 with the removed heat is discharged to the external environment, as indicated by the arrows 124b.

As such, several embodiments of the electronic device 100 can efficiently remove heat via a combination of active and passive heat dissipation without producing excessive noise levels. It has been recognized that passive heat dissipation alone may not achieve sufficient heat removal due to a limitation on surface temperatures of the housing 102. Surface temperatures on the first and/or second housing panels 102a and 102b can be limited to, for example, less than about 48° C. Temperatures higher than 48° C. may cause tissue damage on a user's skin when touching the first and/or second housing panel 102a and 102b of the housing 102. It has also been recognized that relying solely on active heat dissipation may cause excessive noises because forcing a large amount of cooling air through a small internal space can create turbulent flows. As such, by combining active and passive heat dissipation techniques, several embodiments of the electronic device 100 can effectively remove heat produced by the heat source 106 without producing excessive noises. In addition, flow rates that would be required to actively cool the electronic devices may not be feasible due to small thickness values of the electronic devices and available fan capabilities.

FIGS. 1B-1F are schematic diagrams illustrating top views of various embodiments of the electronic device 100 of FIG. 1A configured in accordance with the disclosed technology. In FIGS. 1B-1F, the first housing panel 102a is not shown for clarity of illustrating the internal components of the electronic device 100. In addition, at least a portion of the heat spreader 108 is shown in FIGS. 1B-1F as partially transparent to show arrangement relative to the heat source 106.

As shown in FIG. 1B, the heat spreader 108 can include a first portion 108a and a second portion 108b. The first portion 108a can include a larger surface area than and generally correspond to the heat source 106. The second surface 109b (shown in phantom lines for clarity) of the first portion 108a can be in direct contact with the heat source 106. The second portion 108b can extend laterally away from the first portion 108a and the heat source 106. In the illustrated embodiment, the second portion 108b can be generally aligned with the air mover 120. As such, the air mover 120 can force the cooling air 122 to flow through the first gap 110a between the first surface 109a of the second portion 108b and the first housing panel 102a (FIG. 1A), and the second gap 110b between the second surface 109b of the second portion 108b and the second housing panel 102b. In other embodiments, the second portion 108b can be at least partially offset from the air mover 120 such that the air mover 120 can force the cooling air to flow past at least a part of the first and/or second surfaces 109a and 109b of the first portion 108a of the heat spreader 108.

In operation, the heat source 106 can conduct heat to the first portion 108a of the heat spreader 108 via the second surface 109b The first portion 108a of the heat spreader 108 can then conduct and distribute the received heat to the second portion 108b in a direction 126 that is generally perpendicular or at least partially canted with respect to a direction of the cooling air 122. As shown in FIG. 1B, the first and/or second portions 108a and 108b can have a larger surface area than that of the heat source 106. By distributing the heat removed from the heat source 106 to such a larger surface area, the heat spreader 108 can enhance passive heat dissipation from the electronic device 100 while allowing heat removal to the cooling air 122 via forced convection.

FIG. 1C illustrates another embodiment of the electronic device 100. As shown in FIG. 1C, the heat spreader 108 can have a larger surface area than that of the heat source 106, and the heat spreader 108 can be generally aligned with the air mover 120. As such, the heat source 106 and/or the substrate 104 may at least partially obstruct a flow of the cooling air 122 through the second gap 110b between the second surface 109b and the second housing panel 102b. Even though the heat spreader 108 in FIG. 1C may provide a smaller surface area than that in FIG. 1B, the smaller footprint of the heat spreader 108 in FIG. 1C may allow a compact design of the electronic device 100.

FIG. 1D illustrates yet another embodiment of the electronic device 100. As shown in FIG. 1D, the electronic device 100 can be generally similar to that of FIG. 1B except the heat spreader 108 can include a third portion 108c in addition to the first and second portions 108a and 108b. In the illustrated embodiment, the third portion 108c is generally symmetrical to the second portion 108b with respect to the first portion 108a by extending laterally away from the first portion 108a in a direction opposite of that associated with the second portion 108b. In other embodiments, the third portion 108c can have other suitable dimensions and/or relative positions with respect to the first and/or second portions 108a and 108b. In operation, the third portion 108c can further enhance passive heat dissipation by distributing the heat removed from the heat source 106 to additional surface area via the third portion 108c.

FIG. 1 E illustrates a further embodiment of the electronic device 100. As shown in FIG. 1E, the electronic device 100 can include a first air mover 120a generally corresponding to the second portion 108b of the heat spreader 108 and a second air mover 120b generally corresponding to the third portion 108c of the heat spreader 108. In certain embodiments, the first and second air movers 120a and 120b can be generally similar in structure and/or function. In other embodiments, the first and second air movers 120a and 120b can be different in structure or function.

The second portion 108b and the third portion 108c of the heat spreader 108 can each form first gaps 110a and 110a′ with the first housing panel 102a (FIG. 1A) and second gaps 110b and 110b′ with the second housing panel 102b, respectively. In certain embodiments, the first gaps 110a and 110a′ and/or the second gaps 110b and 110b′ can be isolated from each other, for example, by using baffles (not shown). As such, the first and second air movers 120a and 120b can each move cooling air 122 through corresponding first and second gaps 110a, 110a′, 110b, and 110b′, respectively. In other embodiments, the first gaps 110a and 110a′ and/or the second gaps 110b and 110b′ can be in fluid communication such that cooling air 122 from the first and second air movers 120a and 120b can at least partially mix when flowing from the air inlet 101a toward the air outlet 101b.

In operation, the third portion 108c can further enhance both active and passive heat dissipation by (i) distributing a portion of the heat removed from the heat source 106 to additional surface area via the third portion 108c and (ii) allowing removal of another portion of the heat via forced convection. Even though two separate first and second air movers 120a and 120b are shown in FIG. 1E, in other embodiments, the electronic device 100 can also include a single air mover 120 configured to provide cooling air 122 to both the first gaps 110a and 110a′, as shown in FIG. 1F.

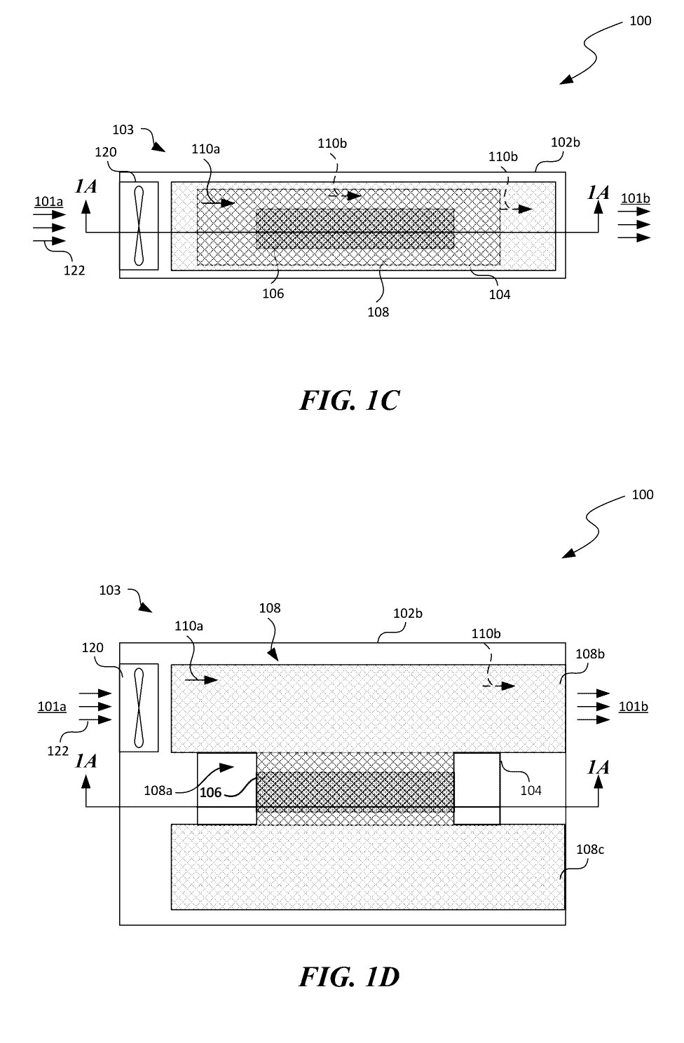

FIGS. 2A-2C are schematic diagrams illustrating cross-sectional and top views of additional embodiments of the heat spreader 108 of FIG. 1A configured in accordance with embodiments of the disclosed technology. Even though the heat spreader 108 are shown in FIG. 1A as having generally planar first and second surfaces 109a and 109b, in certain embodiments, the heat spreader 108 can include non-planar first or second surface 109a or 109b with one or more flow modification features corresponding to the first or second gaps 110a or 110b. By modifying the flow characteristics of the cooling air 122, heat transfer coefficients of different sections of the heat spreader 108 may be modified based on, for instance, a temperature distribution profile on sections of the first and/or second surfaces 109a and 109b of the heat spreader 108 to achieve a desired heat removal profile.

For example, as shown in FIG. 2A, the heat spreader 108 can include a first section 111a and a second section 111b. The first section 111a can include a protrusion 113 extending into the first gap 110a. The protrusion 111 can be generally offset with respect to the heat source 106 along a direction of the cooling air flow. In operation, the second section 111b of the heat spreader 108 may have a higher operating temperature due to close proximity to the heat source 106 than the first section 111a. The protrusion 113 at the first section 111b can reduce a characteristic dimension of the first gap 110a and thus causing the cooling air 122 to have a higher Reynolds number when flowing past the first section 111 a than past the second section 111b. As such, a heat transfer coefficient at the first section 111a can be higher than that of the second section 111 b. As a result, a more uniform heat removal from the heat spreader 108 may be achieved by increasing the heat transfer coefficient of section(s) with lower temperatures and/or decreasing the heat transfer coefficient of other section(s) with higher temperatures.

Even though a protrusion 113 is used in FIG. 2A as an example of a flow modification feature, in other embodiments, the heat spreader 108 can also include other suitable features. For example, as shown in FIG. 2B, the heat spreader 108 can also include a set of baffles 116 configured to force the cooling air to flow past the heat spreader 108 along a serpentine path. In another example, as shown in FIG. 2C, the heat spreader 108 can also include surface features, such as dimples 114 on the first or second surface 109a or 109b.

Without being bound by theory, it is believed that the dimples 114 or other surface features can be configured to prevent or at least delay thermal fully developed flow in the first and/or second gaps 110a and 110b (FIG. 1A). A thermal fully developed flow typically has a generally constant heat transfer coefficient that is much lower than that of a developing flow. The dimples 114 or other surface features can delay or prevent the cooling air 122 (FIG. 1A) to reach thermal fully developed flow as the cooling air 122 flows from the air inlet 101a toward the air outlet 101b (FIG. 1A). As such, the flow of the cooling air 122 along the first and second gaps 110a and 110b can have varying Reynolds and Nusselt numbers. The dimples 114 or other surface features can also help to reduce a thickness of the thermal boundary layer in the first and second gaps 110a and 110b resulting in an increased Nusselt number indicating improved convective heat transfer to the cooling air 122 over conductive heat transfer.

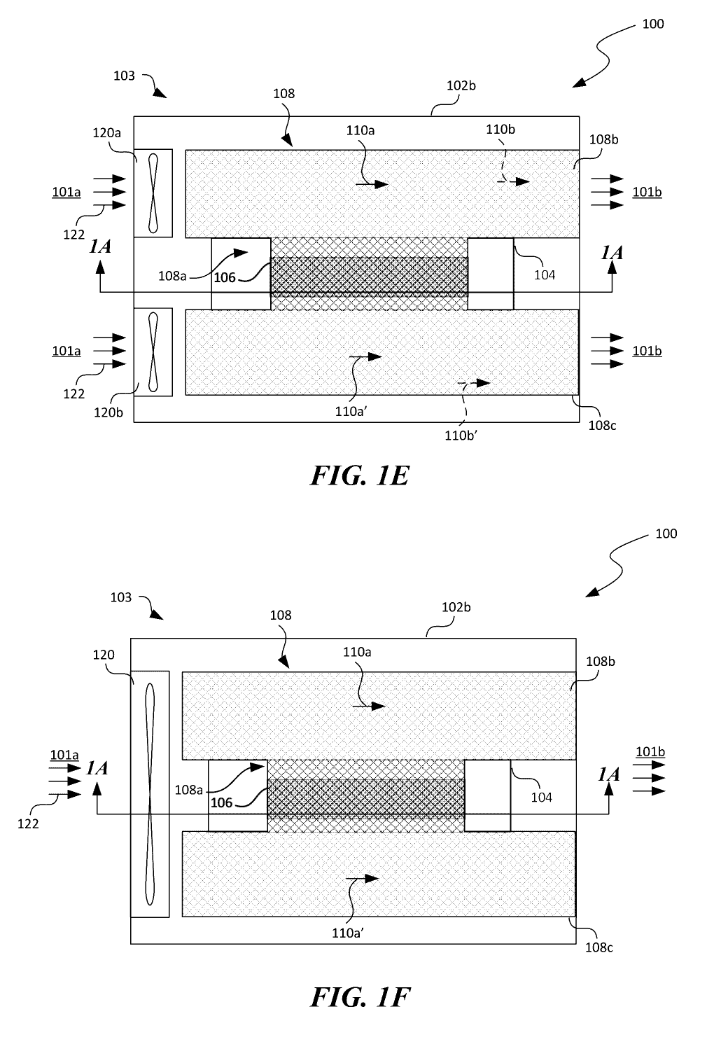

FIG. 3 is a schematic cross-sectional view diagram illustrating additional embodiments of the electronic device 100 of FIG. 1A configured in accordance with embodiments of the disclosed technology. As shown in FIG. 3, the electronic device 100 can be generally similar to that of FIG. 1A except the first and second housing panels 102a and 102b can both include a thermal insulation material 130. The thermal insulation material can include a polymeric material, a ceramic material, or other suitable materials with a thermal conductivity lower than about 50 W/mK. The thermal insulation material 130 can reduce surface temperatures of the first and second housing panels 102a and 102b than without the thermal insulation material 130. As such, the internal components of the electronic device 100 can be configured to operate at higher temperatures than without the insulation material 130.

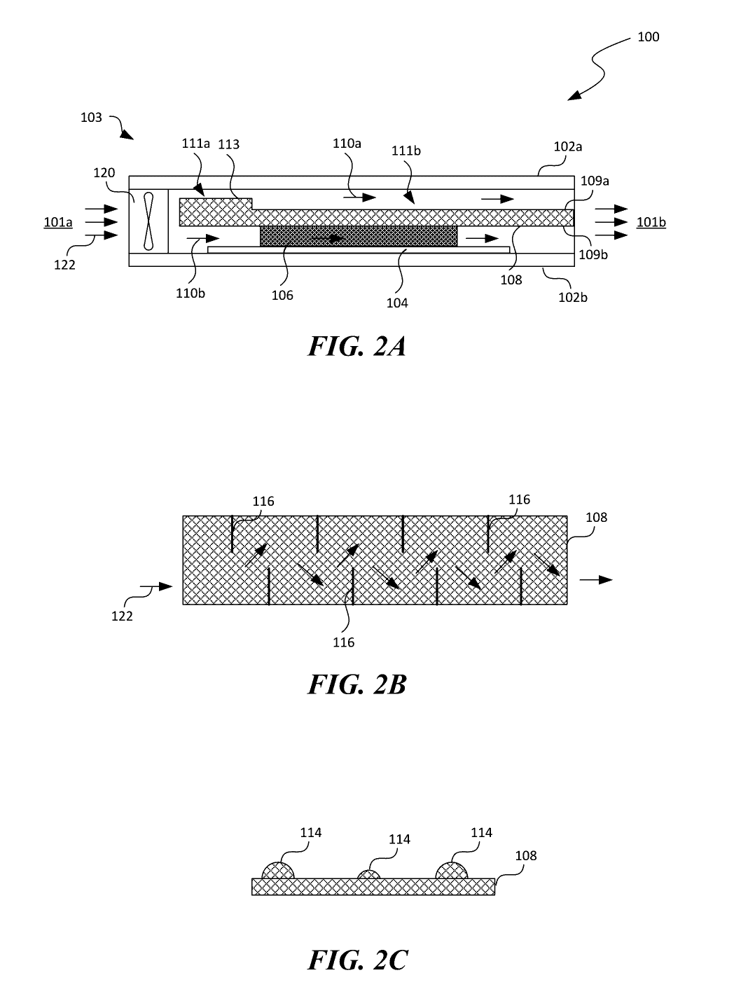

In any of the embodiments described above with reference to FIGS. 1A-3, the heat spreader 108 can also include one or more heat transfer enhancement features. For example, FIGS. 4A and 4B are top and cross-sectional views of a heat spreader 108, respectively, that includes multiple fins 112 on the first surface 109a of the heat spreader 108. Three fins 112 are shown in FIGS. 4A and 4B for illustration purposes. In other embodiments, the heat spreader 108 can also include additional and/or different fins on the first and/or second surfaces 109a and 109b.

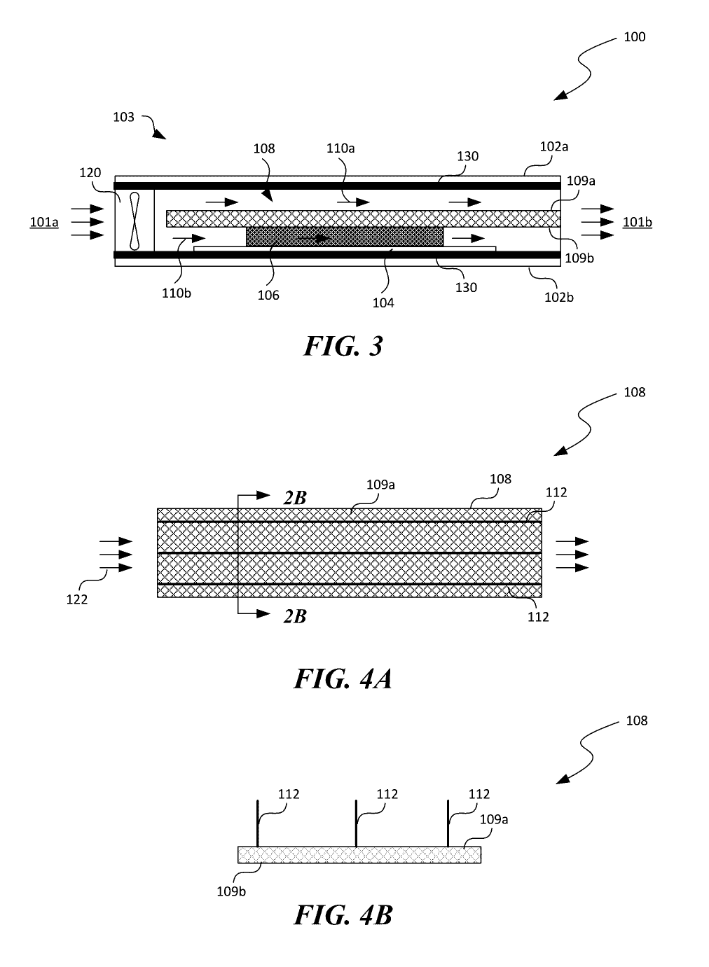

FIG. 5 is a flowchart illustrating a process 200 of removing heat from a heat source in an electronic device in accordance with embodiments of the disclosure. Even though the process 200 is described below with reference to the electronic device 100 of FIGS. 1A-3, in other embodiments, the process 200 may also be performed in other electronic devices or systems with similar or different components.

As shown in FIG. 5, the process 200 includes removing heat from a heat source such as a processor at stage 202. In one embodiment, removing heat from the heat source can include removing heat via conduction, by utilizing, for example, the heat spreader 108 of FIGS. 1A-3. In other embodiments, removing heat from the heat source can include removing heat via convection and/or radiation. The process 200 can then include distributing the removed heat from the heat source to a larger surface area of the electronic device than that of the heat source at stage 204 while providing a coolant (e.g., cooling air) across the surface area at stage 206. The process 200 can then include enhancing passive heat dissipation with the distributed heat at stage 208 and enabling active heat dissipation with the provided coolant at stage 210, as described above with reference to FIGS. 1A-3.

Embodiments of the heat spreader 108 may be incorporated into myriad larger and/or more complex systems 300, a representative one of which is shown schematically in FIG. 5. As shown in FIG. 5, the system 300 can include a processor 301, a memory 302, input/output devices 303, and/or other subsystems or components 304. The heat spreader 108 may be included in any of the components shown in FIG. 5. The resulting system 300 can perform any of a wide variety of computing, processing, storage, sensor, and/or other functions. Accordingly, representative system 300 can include, without limitation, computers and/or other data processors, for example, desktop computers, laptop computers, Internet appliances, and hand-held devices (e.g., palm-top computers, wearable computers, cellular or mobile phones, multi-processor systems, processor-based or programmable consumer electronics, network computers, mini computers). Another representative system 300 can include cameras, light sensors, servers and associated server subsystems, display devices, and/or memory devices. Components of the system 300 may be housed in a single unit or distributed over multiple, interconnected units, e.g., through a communications network. Components can accordingly include local and/or remote memory storage devices and any of a wide variety of computer-readable media, including magnetic or optically readable or removable computer disks.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/we claim:

1. An electronic device, comprising:
a heat source;
a heat spreader having a first surface and a second surface in contact with the heat source, the first surface having a surface area greater than that of the heat source, wherein the heat spreader is configured to remove heat from the heat source via the first surface and distribute the removed heat to the second surface of the heat spreader;
a housing panel spaced apart from the first surface of the heat spreader by a gap; and
an air mover proximate the heat spreader, the air mover being positioned to force cooling air through the gap between the housing panel and the first surface of the heat spreader in a direction generally tangential to the first surface of the heat spreader.

2. The electronic device of claim 1 wherein:
the housing panel is a first housing panel;
the gap is a first gap;
the electronic device further includes a second housing panel opposite the first housing panel;
the second housing panel is separated from the second surface of the heat spreader by a second gap; and
the air mover is positioned to force a portion of the cooling air through the second gap between the second housing panel and the second surface of the heat spreader in a direction generally tangential to the second surface of the heat spreader.

3. The electronic device of claim 1 wherein:
the housing panel is a first housing panel;
the gap is a first gap;
the electronic device further includes a second housing panel opposite the first housing panel;
the second housing panel is separated from the second surface of the heat spreader by a second gap;
the air mover is positioned to force a portion of the cooling air through the second gap between the second housing panel and the second surface of the heat spreader in a direction generally tangential to the second surface of the heat spreader; and
the heat source at least partially obstructs a flow of the cooling air through the second gap.

4. The electronic device of claim 1 wherein:
the heat spreader includes a first portion and a second portion extending away from the first portion;
the first portion is generally corresponding to the heat source;
the second portion is offset from the heat source; and
the second portion is generally aligned with a flow direction of the cooling air from the air mover.

5. The electronic device of claim 1 wherein:
the heat spreader includes a first portion and a second portion extending away from the first portion;
the first portion is generally corresponding to the heat source and is configured to conduct the removed heat from the heat source to the second portion in a first direction; and
the air mover is positioned to force the cooling air to flow past the second portion in a second direction generally perpendicular to the first direction.

6. The electronic device of claim 1 wherein the heat spreader is generally aligned with the heat source and with a flow direction of the cooling air from the air mover.

7. The electronic device of claim 1 wherein:
the heat spreader includes a first portion, a second portion extending away from the first portion in a first direction, and a third portion extending away from the first portion in a second direction opposite the first direction;
the first portion is generally corresponding to the heat source;
the second and third portions are offset from the heat source; and
the second portion is generally aligned with a flow direction of the cooling air from the air mover.

8. The electronic device of claim 1 wherein:
the air mover is a first air mover;
the electronic device further includes a second air mover;
the heat spreader includes a first portion, a second portion extending away from the first portion in a first direction, and a third portion extending away from the first portion in a second direction opposite the first direction;
the first portion is generally corresponding to the heat source;
the second and third portions are offset from the heat source;
the second portion is generally aligned with a flow direction of the cooling air from the first air mover; and
the third portion is generally aligned with a flow direction of the cooling air from the second air mover.

9. The electronic device of claim 1 wherein:
the heat spreader includes a first portion, a second portion extending away from the first portion in a first direction, and a third portion extending away from the first portion in a second direction opposite the first direction;
the first portion is generally corresponding to the heat source;
the second and third portions are offset from the heat source; and
the second and third portions are both generally aligned with a flow direction of the cooling air from the air mover.

10. The electronic device of claim 1 wherein the heat spreader includes a first section and second section extending from the first section along a flow direction of the cooling air, at least one of the first or second section of the heat spreader having a flow modification feature configured to affect a value of Reynolds number associated with the cooling air flowing past the first or second section.

11. The electronic device of claim 1 wherein:
the heat spreader includes a first section and second section extending from the first section along a flow direction of the cooling air;
the first section includes a protrusion into the gap between first surface of the heat spreader and the housing panel; and
the first section corresponds to an area of the first surface having a lower temperature than another area of the first surface corresponds to the second section.

12. An electronic device, comprising:
a processor having a first surface area;
a heat spreader in direct contact with the processor, the heat spreader having a second surface area greater than the first surface area of the processor;
a housing panel spaced apart from the heat spreader by a gap, the housing panel having an air inlet proximate a first end of the gap and an air outlet proximate a second end of the gap; and
an air mover proximate the first or the second end of the gap, the air mover being configured to move cooling air through the gap from the air inlet toward the air outlet of the housing panel.

13. The electronic device of claim 12 wherein the gap has a size that allows a laminar flow of the cooling air from the air inlet toward the air outlet of the housing panel.

14. The electronic device of claim 12 wherein the gap has a size that allows a flow of the cooling air from the air inlet toward the air outlet of the housing panel to have a Reynolds number between about 10 to about 2,000.

15. The electronic device of claim 12 wherein heat spreader includes a vapor chamber having a first surface in contact with the processor and a second surface spaced apart from the housing panel by the gap.

16. The electronic device of claim 12 wherein:
the heat spreader includes a vapor chamber having a first surface in contact with the processor and a second surface spaced apart from the housing panel by the gap; and
the first and second surfaces are generally planar.

17. The electronic device of claim 12 wherein:
the heat spreader includes a vapor chamber having a first surface in contact with the processor and a second surface spaced apart from the housing panel by the gap; and
at least one of the first or second surface is non-planar and having one or more fins.

18. A method of operating an electronic device, comprising:
removing heat produced by a heat source in the electronic device via conduction;
distributing the removed heat to a surface area of a housing panel of the electronic device, the surface area being larger than that of the heat source;
enabling passive heat dissipation through the surface area of the housing panel with the distributed heat;
providing a cooling air to flow from an air inlet of the electronic device, past the surface area of the housing panel, to an air outlet of the electronic device; and
enabling active heat dissipation by expelling the cooling air from the electronic device.

19. The method of claim 18 wherein:
distributing the removed heat includes distributing the removed heat to the surface area in a first direction; and
providing the cooling air includes providing the cooling air to flow from the air inlet of the electronic device, past the surface area of the housing panel, to the air outlet of the electronic device in a second direction generally perpendicular to the first direction.

20. The method of claim 18 wherein:
enabling passive heat dissipation includes enabling heat dissipation from the surface area of the housing panel via at least one of natural convection or radiation; and
enabling active heat dissipation includes enabling heat dissipation to the cooling air via forced convection.
